(19) United States
(12) Patent Application Publication
(10) Pub. No.: US 2012/0120214 A1
(43) Pub. Date: May 17, 2012

(54) Product Demonstration

(75) Inventors: Leo Faranda, Rodgau (DE); Peter Trawinski, Weiterstadt (DE); Eva Kaiser, Kelkheim (DE); Wolfgang Stegmann, Frankfurt am main (DE); Alexander Hilscher, Oberursel (DE)

(73) Assignee: Braun GmbH, Cincinnati, OH (US)

(21) Appl. No.: 12/946,874

(22) Filed: Nov. 16, 2010

(51) Int. Cl. G06F 3/048; H04N 7/18

(52) U.S. Cl. 348/61; 715/810; 348/E07.085

(57) ABSTRACT

Included are embodiments for product demonstration. One embodiment of a system includes a first image capture device that captures a real-time video image of a first product and a memory component that stores a computer application, the computer application causing the system to identify the first product and render an altered version of the real-time video image. The altered version of the real-time video image may include a first virtual menu option that is selectable by the user making a first physical gesture and a second virtual menu option that is selectable by the user making a second physical gesture. Some embodiments include a display device for displaying the altered version of the real-time video image.

### TECHNICAL FIELD

The present application is generally directed to product demonstration and, more particularly, to demonstrating a product via an altered video image.

### BACKGROUND

As consumer products become more sophisticated, consumers may often become confused regarding many of the features that are available for various products. As an example, a product may be available on a store shelf, packaged such that a consumer may not have the ability to handle the product, apart from its packaging. While the packaging may include pictures and/or descriptions regarding its contents, use, etc., consumers often are still left with uncertainty regarding whether the product is designed to address the issue that the consumer wishes to address. Additionally, while oftentimes a store may provide “demo products” that are removed from the packaging to provide the consumer with more information on the product, the consumer may still be left with questions regarding use, results, related products, and/or other issues.

### SUMMARY

Included are embodiments for product demonstration. One embodiment of a system includes a first image capture device that captures a real-time video image of a first product and a memory component that stores a computer application, the computer application causing the system to identify the first product and render an altered version of the real-time video image. The altered version of the real-time video image may include a first virtual menu option that is selectable by the user making a first physical gesture and a second virtual menu option that is selectable by the user making a second physical gesture. Some embodiments include a display device for displaying the altered version of the real-time video image.

Similarly, one embodiment of a product demonstrator device includes an image capture device that captures a real-time video image of a first product and a memory component that stores a computer application, the computer application causing the product demonstrator device to identify the first product and render an altered version of the real-time video image. The altered version of the real-time video image a first virtual menu option that is selectable by the user making a first physical gesture and a second virtual menu option that is selectable by the user making a second physical gesture. Some embodiments include a display device for displaying the altered version of the real-time video image.

Also included are embodiments of a non-transitory computer-readable medium for product demonstration. At least one embodiment of a non-transitory computer-readable medium stores a first computer application that, when executed by a computer, causes the computer to identify the product and render an altered version of a real-time video image. The altered version of the real-time video image may include a first virtual menu option that is selectable by a user positioning the product in a predetermined first orientation. The altered version of the real-time video image may also include a second virtual menu option that is selectable by the user positioning the product in a predetermined second orientation.

### BRIEF DESCRIPTION OF THE DRAWINGS

The following detailed description of specific embodiments of the present disclosure can be best understood when read in conjunction with the drawings enclosed herewith.

FIG. 1 depicts a computing environment, illustrating a system for product demonstration, according to embodiments shown and discussed herein;

FIG. 2 depicts a product demonstrator, which may be utilized in the computing environment of FIG. 1 for product demonstration, according to embodiments shown and described herein;

FIG. 3 depicts a product demonstrator in operation, according to embodiments shown and described herein;

FIG. 4 depicts an interface from the product demonstrator, illustrating a plurality of virtual menu options, according to embodiments shown and described herein;

FIG. 5 depicts an interface from the product demonstrator, illustrating price information associated with a product, according to embodiments shown and described herein;

FIG. 6 depicts an interface from the product demonstrator, illustrating product information, according to embodiments shown and described herein;

FIG. 7 depicts an interface from the product demonstrator, illustrating related products, according to embodiments shown and described herein;

FIG. 8 depicts an interface from the product demonstrator, illustrating use of a product, according to embodiments shown and described herein;

FIG. 9 depicts an interface from the product demonstrator, illustrating an altered version of visual data for demonstrating simulated results of a product, according to embodiments shown and described herein;

FIG. 10 depicts a flowchart for rendering an altered version of visual data, according to embodiments shown and described herein;

FIG. 11 depicts a flowchart for communicating with a product to provide an altered version of visual data, according to embodiments shown and described herein; and

FIG. 12 depicts a flowchart for providing additional product data, according to embodiments shown and described herein.

The embodiments set forth in the drawings are illustrative in nature and not intended to be limiting of the disclosure defined by the claims. Moreover, individual features of the drawings and disclosure will be more fully apparent and understood in view of the detailed description.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

Embodiments disclosed herein may be configured as a system, device, method, and/or non-transitory computer-readable medium for demonstrating a product and related data via a real-time video image, as well as providing an altered version of the real-time video image to create an interactive interface. In some embodiments, the user may stand within range of an image capture device, such as a camera, with a product also within range of the image capture device. The image capture device may be configured to capture a real-time video image of the user and product. The image capture device may also be physically and/or communicatively coupled to a computing device and a display device. The computing device may include a memory component that stores a computer application that causes the computing device to utilize product identification data to identify the product. Additionally, the computer application may cause the computing device to alter the real-time video image to provide an interactive menu for that product. Menu options may be selected by the user positioning the product in a predetermined orientation, within view of the image capture device.

As an example, if a user enters a store and locates a product of interest, the user may hold the product within view of an image capture device that is coupled to the product demonstrator. The product demonstrator may identify the product from the image and/or via communication with the product. The product demonstrator may additionally provide an interactive interface to the user that is specific to the product being identified. More specifically, upon identifying the product, the product demonstrator may alter the real-time video image to provide a plurality of virtual menu options. The user may select one of the menu options by performing a triggering action. A triggering action may include any action to select an option, including holding the product in a predetermined orientation for a predetermined amount of time. Other triggering actions may include user input via a mouse, keyboard, touch screen, etc., a predetermined motion by the user, and/or other triggering actions. Additionally, the user can view the other menu options by changing the present orientation of the product. The other menu options may be selected by the product demonstrator 102 detecting the product in the new orientation and receiving a triggering action. From the selected menu option, the user may be provided with a plurality of virtual menu sub-options and/or data related to the product.

Similarly, in some embodiments, the product demonstrator may not utilize the image capture device to identify the product. More specifically, the product demonstrator may receive a product identifier and simply determine the product from the identifier. The product identifier may include an image sent from a remote device (such as a mobile device that includes a second image capture device), a product name, a product number, and/or other identifiers. Additionally, the identifier may be sent from a user and/or a remote device via a wired or wireless protocol, such as via an audio signal (e.g., the user speaking to the product demonstrator), via a Bluetooth™ protocol, via a Wi-Fi protocol, via a Wi-Max protocol, via a mobile communications protocol, and the like.

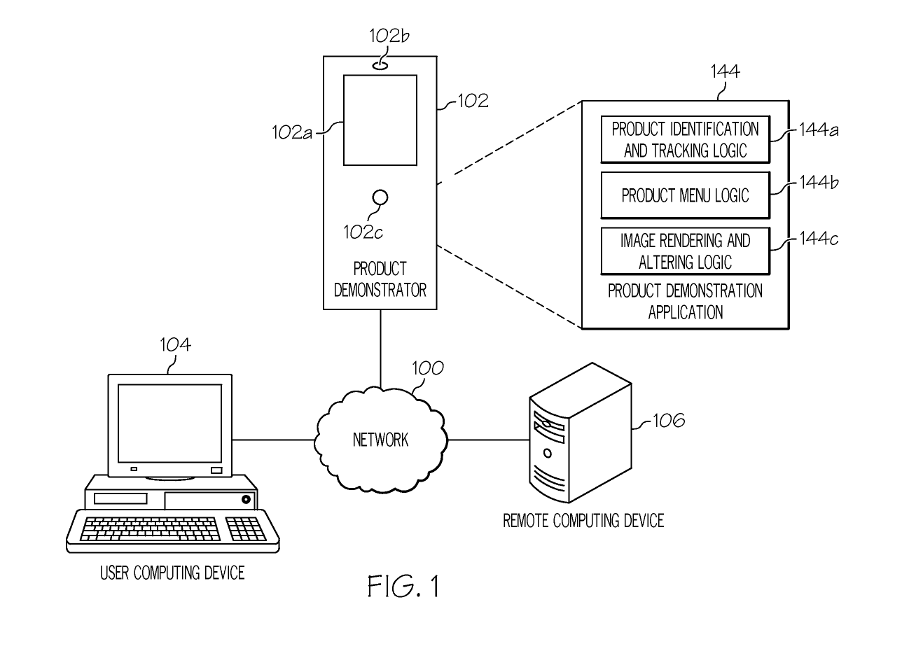

Referring now to the drawings, FIG. 1 depicts a computing environment, illustrating a system for product demonstration, according to embodiments shown and discussed herein. As illustrated in FIG. 1, a network 100 may include a wide area network, such as the Internet, a local area network (LAN), a mobile communications network, a public service telephone network (PSTN) and/or other network and may be configured to electronically couple a product demonstrator 102, a user computing device 104, and a remote computing device 106.

More specifically, the product demonstrator 102 may be configured as a computing device, mobile telephone, personal digital assistant, laptop computer, tablet, electronic kiosk, and/or other device. Additionally, the product demonstrator 102 may include and/or be coupled to a display device 102a, an image capture device 102b, and an audio device 102c. The display device 102a may be any device for providing a graphical user interface. The display device 102a may be integral to the product demonstrator, and/or may be a separate component in a system for product demonstration. Similarly, the image capture device 102b may be positioned on and/or be communicatively coupled (via a wired and/or wireless connection) to the product demonstrator 102. The image capture device 102b may be configured to capture real-time video images, still images, 3-dimensional images, and/or other images. Also included is the audio device 102c that may also be physically integral to the product demonstrator 102 and/or physically separate from the product demonstrator 102. The audio device 102c may be configured as a speaker and/or microphone for receiving and/or providing audio data to the user.

Also included in the product demonstrator 102 is a product demonstration application 144, which includes product identification and tracking logic 144a, product menu logic 144b, and image rendering and altering logic 144c. As described in more detail below, the product identification and tracking logic 144a may be configured to cause the product demonstrator 102 to receive image data (such as real-time video images) and determine, from the received image data, at least one product. Additionally, the product identification and tracking logic 144a may be configured to track the location of the identified product within the image, regardless of movement of the product. Similarly, the product menu logic 144b may be configured to cause the product demonstrator 102 to determine a virtual menu for the identified product. Similarly, the real-time video rendering and altering logic 144c may be configured to render a real-time video image for display, as well as alter the imagery, as described in more detail below.

Also illustrated in FIG. 1 is the user computing device 104. The user computing device 104 may be configured to communicate with the product demonstrator 102 via the network 100. In some embodiments, the product demonstrator 102 may send stored data to the user computing device 104 for later access by a user. As an example, the product demonstrator 102 may identify the user and receive an indication that the user wishes to be sent information regarding the product. Accordingly, the product demonstrator 102 may send the product information to the user computing device 104. Similarly, in some embodiments, a user may make one or more preference selections (such as previously purchased products, allergies, etc.) on the user computing device 104. This data may be sent to the product demonstrator 102 to enhance accuracy of determinations made by the product demonstrator 102.

Similarly, the remote computing device 106 may also be coupled to the network 100 and may be configured to communicate with the product demonstrator 102 (and/or with the user computing device 104) to receive usage data of the product demonstrator for tracking statistics, purchases, etc. Such information may be utilized to further enhance the accuracy of the product demonstrator 102.

It should be understood that while the product demonstrator 102, the user computing device 104, and the remote computing device 106 are depicted as kiosks, personal computers and/or servers, these are merely examples. More specifically, in some embodiments any type of computing device (e.g. kiosk, mobile computing device, personal computer, server, etc.) may be utilized for any of these components. As an example, while the product demonstrator 102 may be configured as an integrated product demonstrator device, in some embodiments, the product demonstrator 102 may be configured as a system, where the components are not physically integrated within a single housing. Along those lines, while each of these computing devices is illustrated in FIG. 1 as a single piece of hardware, this is also an example. More specifically, each of the computing devices 102-106 may represent a plurality of computers, servers, databases, etc.

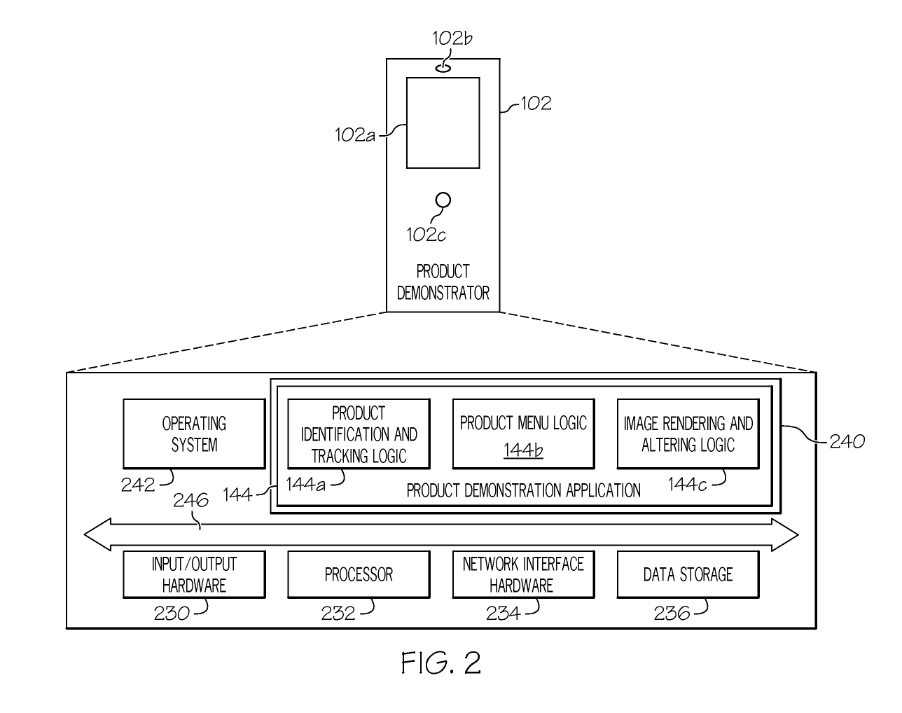

FIG. 2 depicts the product demonstrator 102, which may be utilized in the computing environment of FIG. 1 for product demonstration, according to embodiments shown and described herein. In the illustrated embodiment, the product demonstrator 102 includes input/output hardware 230, a processor 232, network interface hardware 234, a data storage component 236 (which stores the user data, product data, and/or other data), and a memory component 240. The memory component 240 may be configured as volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the product demonstrator 102 and/or external to the product demonstrator 102.

Additionally, the memory component 240 may be configured to store operating logic 242 and a product demonstration application 144. The product demonstration application 144 may include a plurality of different pieces of logic, some of which include the product identification and tracking logic 144a, the product menu logic 144b, and the real-time video image rendering and altering logic 144c, each of which may be embodied as a computer program, firmware, and/or hardware. A local interface 246 is also included in FIG. 2 and may be implemented as a bus or other interface to facilitate communication among the components of the product demonstrator 102.

The processor 232 may include any processing component operable to receive and execute instructions (such as from the data storage component 236 and/or memory component 240). The input/output hardware 230 may include and/or be configured to interface with a monitor, keyboard, mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the product demonstrator 102 and other computing devices. Similarly, it should be understood that the data storage component 236 may reside local to and/or remote from the product demonstrator 102 and may be configured to store one or more pieces of data for access by the product demonstrator 102 and/or other components.

Included in the memory component 240 are the operating logic 242 and the product demonstration application 144. The operating logic 242 may include an operating system and/or other software for managing components of the product demonstrator 102. Similarly, as discussed above, the product demonstration application 144 may reside in the memory component 240 and may be configured to cause the input/output hardware 230 identify a product from a received real-time video image, an interactive menu specific to the determined product, and alter the real-time video image, based on whether the potential product is in the real-time video image. Other functionality is also included and described in more detail, below.

It should be understood that the components illustrated in FIG. 2 are merely exemplary and are not intended to limit the scope of this disclosure. While the components in FIG. 2 are illustrated as residing within the product demonstrator 102, this is merely an example. In some embodiments, one or more of the components may reside external to the product demonstrator 102. It should also be understood that, while the product demonstrator 102 in FIGS. 1 and 2 is illustrated as a single device, this is also merely an example. In some embodiments, the product identification and tracking functionality, the product menu functionality, and the real-time video image rendering and altering functionality may reside on different devices.

Additionally, while the product demonstrator 102 is illustrated with the product identification and tracking logic 144a, the product menu logic 144b, and the real-time video image rendering and altering logic 144c, as part of the product demonstration application 144, this is also an example. More specifically, in some embodiments, a single piece of logic may perform the described functionality. Similarly, in some embodiments, this functionality may be distributed to a plurality of different pieces of logic, which may reside in the product demonstrator 102 and/or elsewhere. Additionally, while only one application is illustrated as being stored by the memory component 240, other applications may also be stored in the memory component 240 and utilized by the product demonstrator 102.

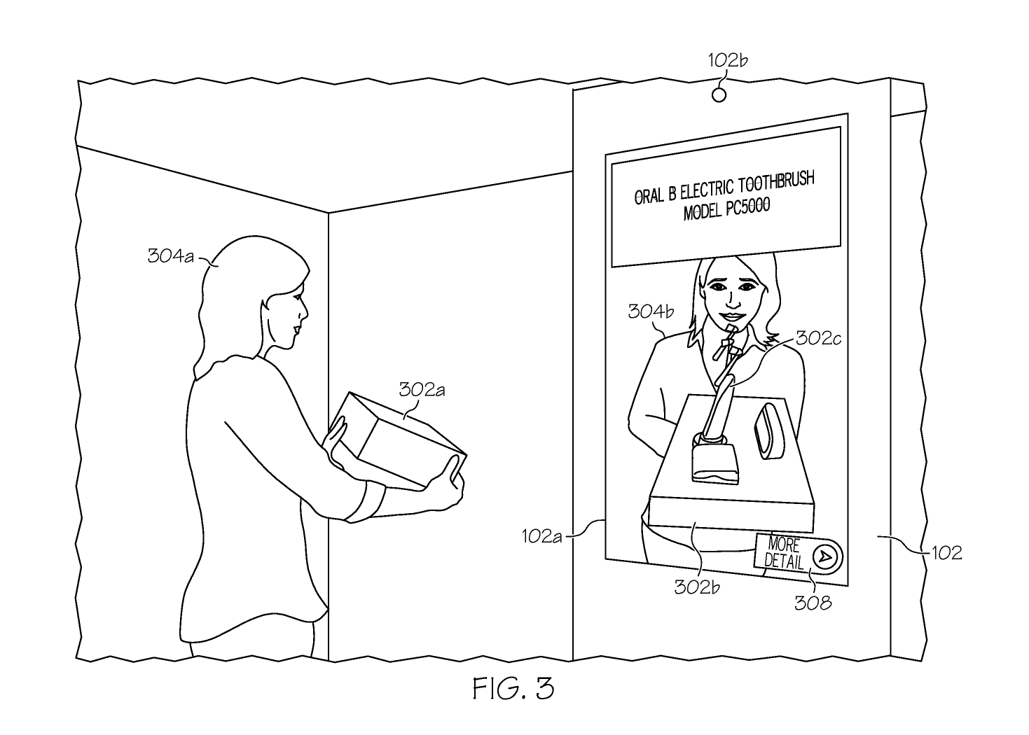

FIG. 3 depicts the product demonstrator 102 in operation, according to embodiments shown and described herein. As illustrated, the product 302a may be held by a user 304a. Additionally, the user 304a and the product 302a may be within the range of the image capture device 102b. Accordingly, the image capture device 102b may be configured to capture an image of the user 304a and the product 302a and display these items in the display device 102a. Additionally, the product demonstrator 102 may be configured to identify the product 302a.

The product demonstrator 102 may identify the product 302a from the real-time video image and/or via a communication with the product 302a. As an example, in some embodiments, the image capture device 102b can capture an image of the product 302a. From this image of the product 302a, the product demonstrator 102 can identify natural features (such as color, shape of packaging, shape of product, etc.) to identify the product 302a. Similarly, the product demonstrator 102 may be configured to identify (from the image) markers, such as bar codes, radio frequency identifier (RFID) tags, price stickers, and/or other markers. In some embodiments, the product 302a may include communication capabilities to facilitate 1-way and/or 2-way communication with the product demonstrator 102. From this communication, the product demonstrator 102 may identify the product 302a.

Once the product 302a has been identified, the product demonstrator 102 can determine product-specific information, as well as a product-specific alteration to make to the real-time video image. As an example, in addition to rendering a virtual product 302b and a virtual user 304b, the product demonstrator 102 may additionally alter the real-time video image to provide a virtual product alteration 302c. More specifically, in the embodiment of FIG. 3, the product 302a is packaged and, as such, the alteration may include presenting an image of the product outside of the packaging. Additional product information may also be provided via selection of a more detail option 308.

It should be understood that the user 304a may select the more detail option 308 via any of a number of different ways. As an example, the display device 102a may be configured as a touch screen, where the user may simply touch that portion of the screen. In some embodiments, the user may simply direct the product 302a, such that a predetermined portion of the virtual product 302b touches the more detail option 308. In some embodiments, the user may access a keyboard, mouse, controller, and/or other device for selecting the more detail option 308. Similarly, in still some embodiments, the user 304a may move such that the virtual user 304b touches the desired option.

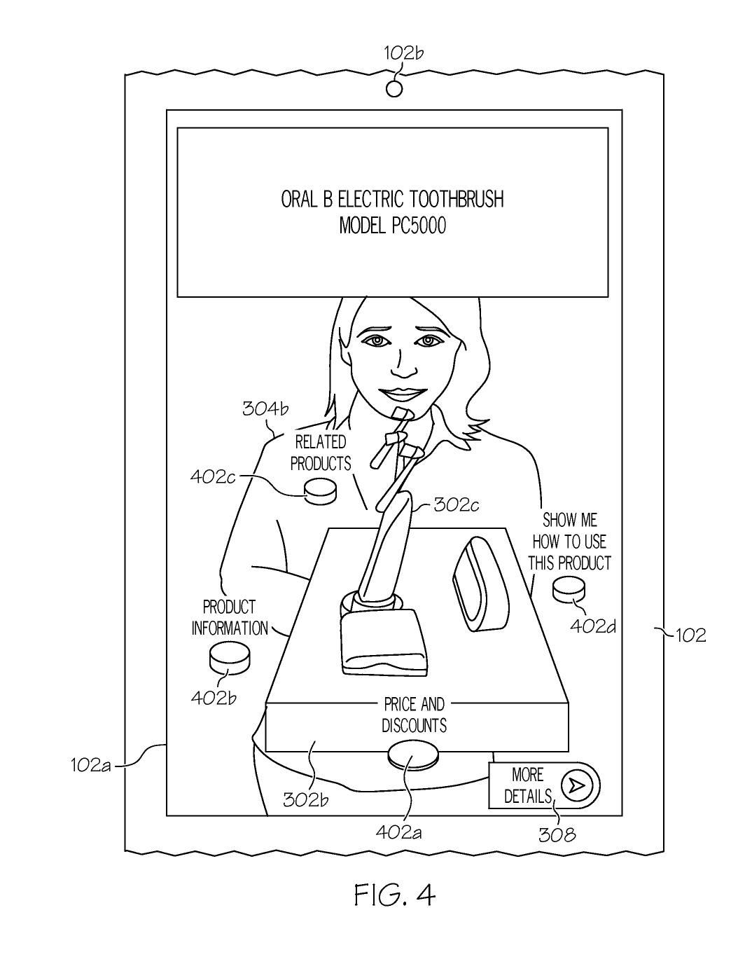

FIG. 4 depicts an interface from the product demonstrator 102, illustrating a plurality of virtual menu options 402, according to embodiments shown and described herein. As illustrated, in addition to the virtual product 302b, the virtual user 304b, and the virtual product alteration 302c, the product demonstrator 102 may also provide a plurality of menu options 402a-402d that provide additional product information to the user. As illustrated, by holding the product 302a (and thus virtual product 302b) as illustrated in FIG. 4 or otherwise making a physical gesture, a “price and discounts” virtual menu option 402a is available for selection. Additionally, by holding the product 302a in this orientation for a predetermined amount of time (or otherwise performing a triggering action), the price and discounts virtual menu option 402a may be selected.

Also included in the example of FIG. 4 are a “product information” virtual menu option 402b, a “related products” virtual menu option 402c, and a “show me how to use this product” virtual menu option 402d. By rotating and/or otherwise orientating the in a predetermined manner, these virtual menu options may be available to the user 304a.

It should be understood that while the embodiment of FIG. 4 illustrates that the user and the product are within range of the image capture device 102b, this is merely an example. More specifically, in some embodiments (such as if the product is large, bulky, heavy, not currently available), the user may simply identify the product and the product demonstrator 102 can render an altered version of the real-time video image that includes the user holding the virtual product. As the user is not actually holding the product in such an embodiment, the user may select the virtual menu options by making other physical gestures that are perceptible by the image capture device 102b. While physical gestures may include positioning the product in a predetermined orientation, some physical gestures may include a virtual tap of an option, a physical tap of an option (e.g., via a touch screen on the product demonstrator 102), hand motions, moving, and/or other gestures.

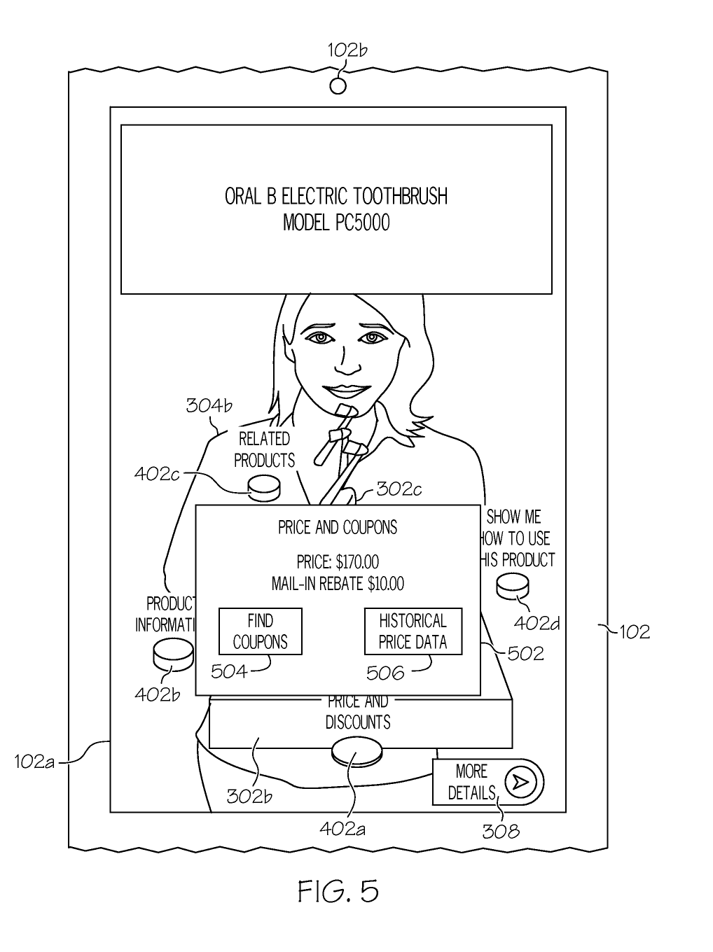

FIG. 5 depicts an interface from the product demonstrator 102, illustrating price information associated with the product 302a, according to embodiments shown and described herein. As shown, in response to a physical gesture, such as holding the product 302a in a predetermined orientation for a predetermined amount of time (or otherwise performing a triggering action), information related to price and coupons for the product 302a may be provided via a menu overlay 502. The menu overlay 502 may include price information, as well as a “find coupons” option 504, and an “historical price data” option 506. By selecting the find coupons option 504, information regarding available coupons and/or discounts for the product 302a may be provided. Available coupons may be stored locally on the product demonstrator 102 and/or may be stored remotely and accessible via a wide area network and/or local area network. In some embodiments, the product demonstrator 102 may be configured to print (or be coupled to a printing device, such as a printer) a rebate, a coupon, product use information, product feature information, and/or other information.

Similarly, by selecting the historical price data option 506, information regarding past purchases and/or future price predictions may be provided. As an example, if the price of the product 302a has declined by 10% each month for the last 6 months, the product demonstrator 102 can provide this information to the user 304a. With this information, the user 304a (and/or the product demonstrator 102) can predict that the price will continue to decline at a similar rate over the next month. Thus, the user 304a can determine whether to purchase the product 302a now or wait for future price reductions.

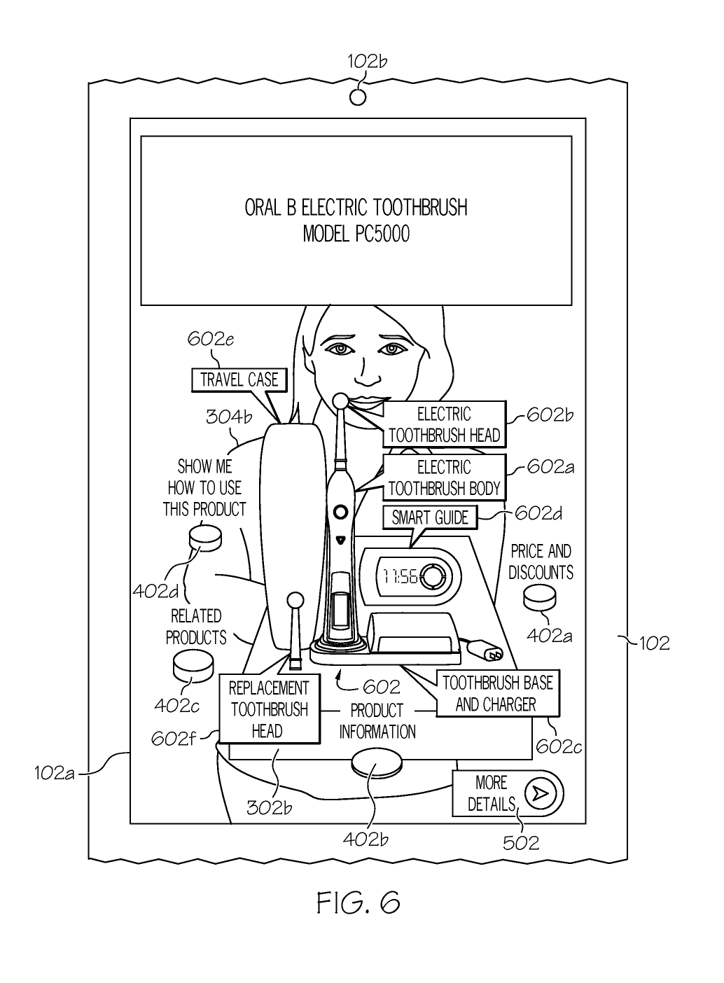

FIG. 6 depicts an interface from the product demonstrator 102, illustrating product information, according to embodiments shown and described herein. As shown in FIG. 6, the user 304a has rotated the product 302a to correspond with the product information virtual menu option 402b (and/or made another physical gesture). Additionally, the user 304a has performed a triggering action to select the product information virtual menu option 402b. In response, the product demonstrator 102 can alter the real-time video image to provide the virtual product 602, as well as one or more indicators 602a-602f for providing information related to the virtual product 602. More specifically, in the example from FIG. 6, the Oral B Electric Toothbrush, Model PC5000 includes an electric toothbrush body 602a, a toothbrush head 602b, a toothbrush base and charger 602c, a smart guide 602d, a travel case 602e, and a replacement toothbrush head 602f. Additionally, a “more details” option 604 may be included for providing additional product information.

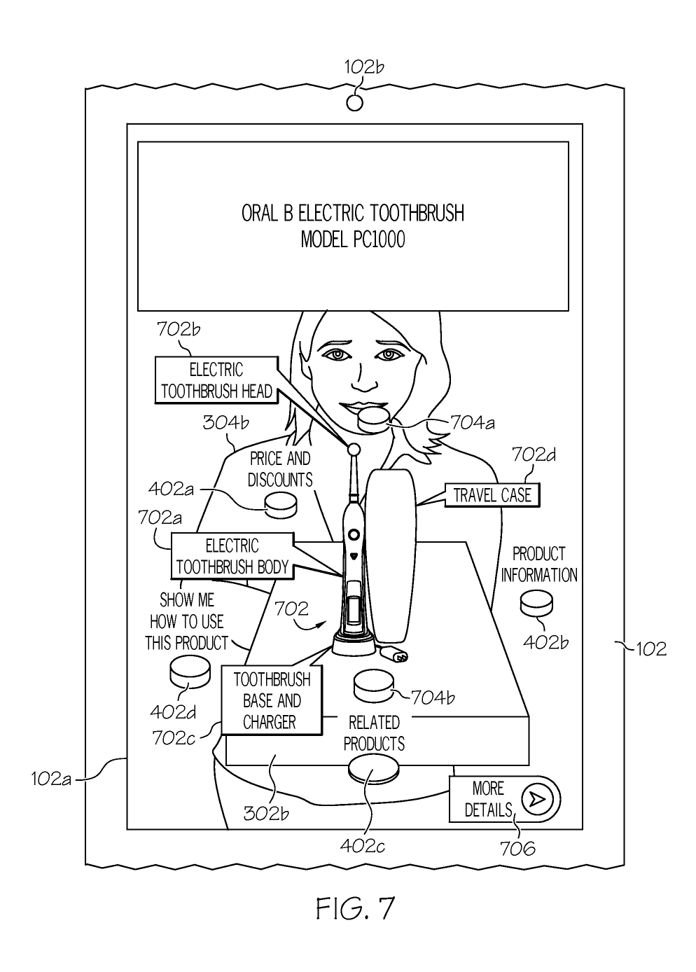

FIG. 7 depicts an interface from the product demonstrator 102, illustrating related products, according to embodiments shown and described herein. As shown, the product demonstrator 102 may be configured to provide information related to an alternate product 702 to the product that the user is holding. More specifically, as the user holds the product 302a in a predetermined orientation (or performs other physical gestures), and performs a triggering action, the real-time video image may be further altered to provide a virtual image of the alternate product 702 (different than the product 304a that the user is holding). In the example shown in FIG. 7, the Oral B PC1000 is provided. According to the altered version of the real-time video image, the Oral B PC1000 includes a toothbrush body 702a, a toothbrush head 702b, a toothbrush base and charger 702c, and a toothbrush travel case 702d.

Additionally, a plurality of virtual sub-options 704 may also be provided to the user. The virtual sub-options 704 may be associated with other products that are related to the product 302a (FIG. 3). While the virtual menu options 402 are arranged around a first virtual plane (e.g. the horizontal plane), the virtual sub-options may be arranged along a second virtual plane (e.g. the vertical plane). This allows the user 304a to select one or more virtual sub-options 704 by rotating the product 302a vertically. As an example, if the user 304a rotates the product 302a vertically and positions the product 302a in a predetermined orientation, a different related product may be displayed. Additionally, if the user selects a more details option 706, additional information (such as features, price and discount information, usage information, location of the product, and/or other information) may be provided.

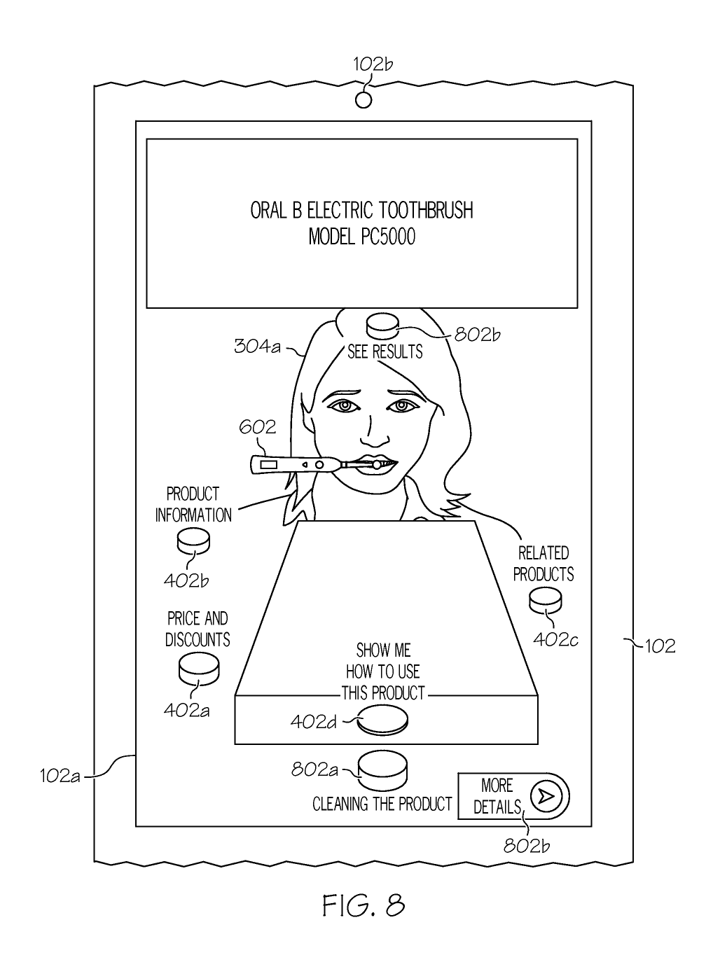

FIG. 8 depicts an interface from the product demonstrator 102, illustrating use of a product 302a, according to embodiments shown and described herein. As shown, by positioning the product 302a in a predetermined orientation that corresponds to the “show me how to use product” virtual menu option 402d (or performing other physical gesture), the user can view an altered version of the real-time video image that illustrates utilization of the product 302a via the virtual product 602. More specifically, in the example from FIG. 8, the product 302a is an electric toothbrush. By holding the product 302a in a predetermined orientation and performing a triggering action, the product demonstrator 102 can move the virtual product 302b up to the mouth of the virtual user 304b to begin showing proper usage of the electric toothbrush. Additionally, audio instructions may be provided. The audio instructions may include discussion of how to operate the toothbrush, and/or instructions to the user to better show the proper technique. As an example, if the user 304a has her mouth closed, the product demonstrator 102 can recognize that the mouth of the virtual user 304b is shut and provide a command, such as “please open your mouth.”

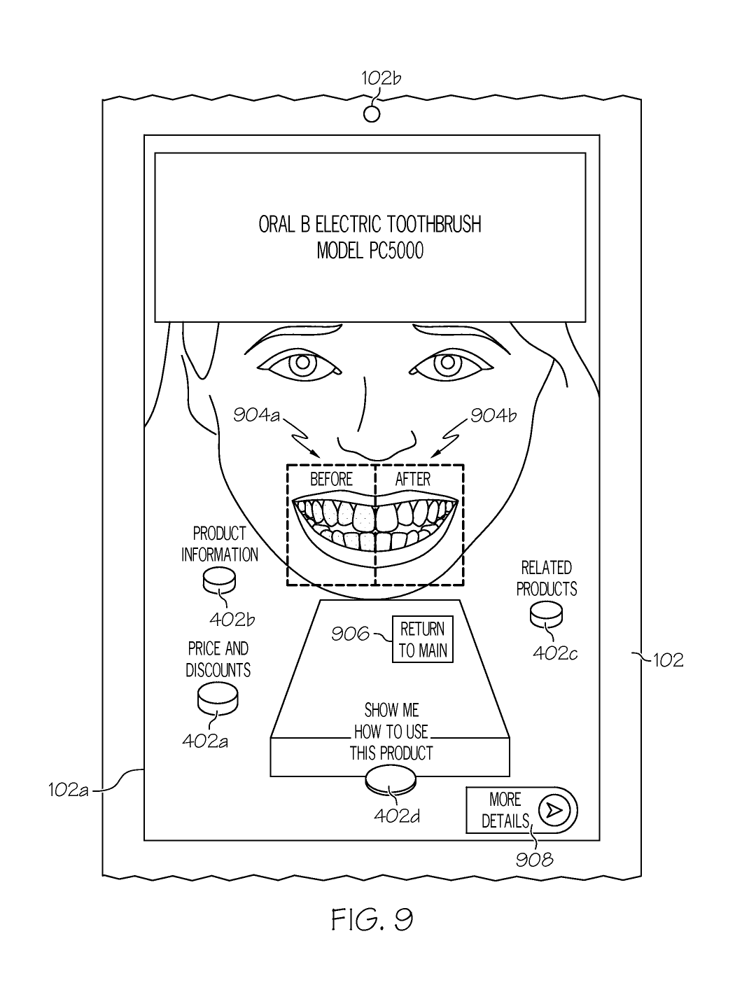

Additionally included in the embodiment of FIG. 8 are virtual sub-options 802a and 802b. The virtual sub-option 802a may be configured to provide information on how to clean the toothbrush. Additionally, by selecting the virtual sub-option 802b, the product demonstrator 102 can provide results information, as described below, with regard to FIG. 9.

It should be understood that while, in some embodiments, the product demonstrator 102 may direct usage of the virtual product 602, this is just an example. In some embodiments, the user 304a may move their hand (and/or body) to show how the user 604a would operate the product 302a. The product demonstrator 102 may provide feedback regarding the user's technique.

FIG. 9 depicts an interface from the product demonstrator 102, illustrating an altered version of visual data for demonstrating simulated results of a product, according to embodiments shown and described herein. As shown, in response to selecting the virtual sub-option 802b, from FIG. 8, the product demonstrator 102 can provide an altered version of the real-time video image to more clearly illustrate the results that the user could achieve if he/she utilizes the product 302a. In the particular example of FIG. 9, a partially altered image is included, where the left portion shows the actual real-time video image 904a of the user's teeth and the right portion shows an altered version of the real-time video image 904b that illustrates the results that the user could achieve if the user uses the product. As will be understood the actual real-time video image 904a may represent a “before” image and the altered version of the real-time video image may represent an “after” image to indicate these predicted results. Additionally included are a “return to main” option 906 and a “more details” option 908. The return to main option 906 allows the user 304a to return to the previous interactive interface, from FIG. 8. However, the more details option 908 may be configured to provide the user 304a with the ability to show a result, based on varying types of usages over time. As an example, the altered version of the real-time video shown in FIG. 9 may provide default results, based on the manufacturer's recommend usage. However, if the user desires to view results that will likely occur if the user follows a portion (or alteration) of the manufacturer's recommended usage, the user may select the more details option 908 to provide the additional options and/or data.

As discussed above, in some embodiments, the user 304a can control operation of the virtual product 602. Accordingly, in some embodiments, the interface from FIG. 9 can show the user 304a the results of their operation. If the user missed areas during operation, the product demonstrator 102 can highlight those areas to help the user improve their technique.

It should also be understood that while the examples in FIGS. 3-9 refer to a toothbrush as a product, these are merely examples. More specifically, any product may be demonstrated, including beauty and grooming products, health and wellbeing products, household care products, etc. Examples of beauty and grooming products include, but are not limited to shavers, stylers, and trimmers, elipators, hair removers, hair straighteners, hair curlers, hair airstylers, and hair brushes. Examples of household care products include, but are not limited to blenders, mixers, mincers, steamers, toasters, juicers, coffee makers, water kettles, coffee grinders, and irons. Similarly, while much of the discussion herein refers to a product 304a that a user can purchase, in some embodiments, a user can hold a previously purchased product in front of the image capture device 102b (e.g., bring a product from home). In such situations, the product demonstrator 102 can identify the product and provide an interactive menu (as described above) to provide replacement products, cleaning products, usage information, and/or other data.

Additionally, products within the scope of this disclosure include a number of absorbent article products, such as diapers, training pants, adult incontinence products, feminine hygiene garments, facial tissues, bathroom tissues, paper towels and paper napkins In some embodiments, the product may include, for example, laundry or other type of detergents, fabric softeners, bleaches, fabric pretreaters and/or dryer sheets. In still some embodiments, the product may include, for example, dishwashing detergents, glass cleaners, hard surface cleaners, fabric deodorizers, air fresheners, and/or hard surface sanitizers. In some embodiments, the product may include, for example, cosmetics, gift packs, electric or manual appliances, razors, hair products, skin products, pet food products, a consumable product such as food, etc. Other types of products are also included within the scope of this disclosure.

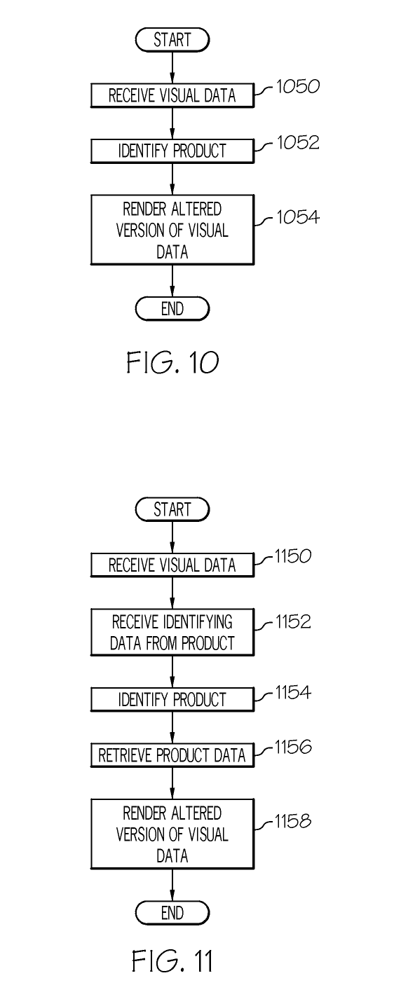

FIG. 10 depicts a flowchart for rendering an altered version of visual data, according to embodiments shown and described herein. As illustrated in block 1050, the product demonstrator 102 can receive visual data of a product 302a from the image capture device 102b. In block 1052, the product demonstrator 102 can additionally identify the product 302a. The product 302a may be identified from natural features, markers, and/or via a communication with the product 302a, itself, etc. Regardless of the mechanism for identification, in block 1054, the product demonstrator 102 can render an altered version of the visual data to provide an interactive interface with a plurality of virtual menu options that may be selected by the user 304a performing a physical gesture, such as positioning the product 302a in a plurality of respective orientations.

FIG. 11 depicts a flowchart for communicating with a product 304a to provide an altered version of visual data, according to embodiments shown and described herein. As illustrated in block 1150, the product demonstrator 102 can receive visual data. As described above, the visual data may include a real-time video image, still image, and/or other visual data. At block 1152, the product demonstrator 102 can receive identifying data from the product 302a. The identifying information may include a wired or wireless communication from the product 302a itself that identifies the product 302a to the product demonstrator 102. At block 1154, the product demonstrator 102 utilizes this information to identify the product 302a. At block 1156, the product demonstrator 102 can retrieve product data. The product data may be stored locally and/or remotely and may include image data for altering the visual data received from the image capture device 102b. At block 1158, the product demonstrator 102 can render the altered version of the visual data to provide at least a portion of the product data. As discussed above, rendering the altered version of the visual data may include providing an interactive interface that includes a plurality of virtual menu options that are selectable by a user performing a physical gesture, such as positioning the product in a predetermined orientation.

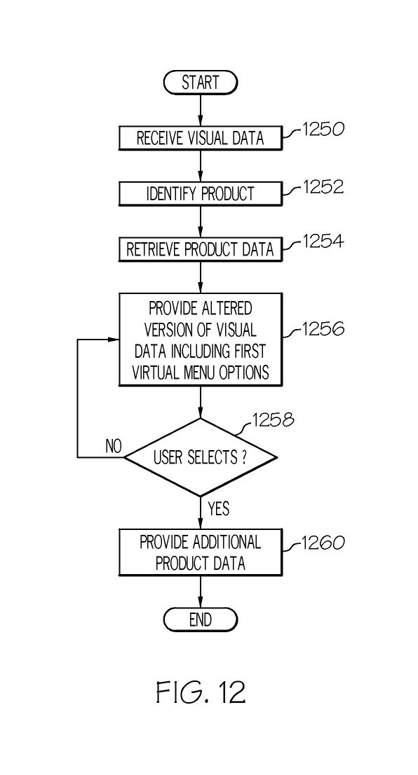

FIG. 12 depicts a flowchart for providing additional product data, according to embodiments shown and described herein. As illustrated in block 1250, the product demonstrator 102 can receive visual data, such as from the image capture device 102b. At block 1252, the product demonstrator 102 can identify the product 302a. At block 1254 the product demonstrator 102 can retrieve the product data from a local and/or remote location. At block 1256, the product demonstrator 102 can provide an altered version of the visual data, including a set of first virtual menu options. At block 1258, a determination can be made regarding whether the user selected any of the virtual menu options. If not, the process returns to block 1256. If the user has selected one or more of the virtual menu options, the process proceeds to block 1260, where the product demonstrator 102 provides additional product data, as described above.

It should be understood that while the embodiments above describe the identification of a single product, these are merely examples. More specifically, in some embodiments, the product demonstrator 102 may be configured to identify a plurality of products and render an altered version of the real time video image to provide corresponding virtual products. Additionally, in such embodiments, comparison data among the plurality of products may be provides such as by the virtual menu options.

Additionally, in some embodiments, a system for product demonstration, may include a first image capture device that captures a real-time video image of a user and a memory component that stores a computer application, the computer application causing the system to identify a first product and render an altered version of the real-time video image. In some embodiments, the altered version of the real-time video image include the real-time video image of the user, an image of a first virtual product that is associated with the first product, a first virtual menu option that is selectable by the user making a first physical gesture, and a second virtual menu option that is selectable by the user making a second physical gesture. Some embodiments include a display device for displaying the altered version of the real-time video image.

Similarly, some in embodiments, a demonstrator device for product demonstration includes an image capture device that captures a real-time video image of a user and a memory component that stores a computer application, the computer application causing the product demonstrator device to identify a first product and render an altered version of the real-time video image. The altered version of the real-time video image may include the real-time video image of the user, an image a first virtual product that is associated with the first product, a first virtual menu option that is selectable by the user making a first physical gesture, and a second virtual menu option that is selectable by the user making a second physical gesture. Some embodiments include a display device for displaying the altered version of the real-time video image.

Further, in some embodiments, systems for product demonstration may include an image capture device for capturing a real-time video image of a user and a memory component that stores a computer application, that when executed by a computer, causes the system to identify a product and render an altered version of the real-time video image. The altered version of the real-time video image may include a first portion that includes an current version of a part of the real-time video image and a second portion that includes a predicted version of the real-time video image, the predicted version of the real-time video image signifying a predicted result of using the product. Some embodiments include a display device for displaying the altered version of the real-time video image.

It should also be understood that, unless a term is expressly defined in this specification using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present disclosure unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

While particular embodiments have been illustrated and described, it would be understood to those skilled in the art that various other changes and modifications can be made without departing from the spirit and scope of the disclosure. It is therefore intended to cover in the appended claims all such changes and modifications that are within the scope of this disclosure.

Therefore, at least the following is claimed:

1. A system for product demonstration, comprising:
a first image capture device that captures a real-time video image of a first product;
a memory component that stores a computer application, the computer application causing the system to perform at least the following:
identify the first product; and
render an altered version of the real-time video image, the altered version of the real-time video image including a first virtual menu option that is selectable by a user making a first physical gesture and a second virtual menu option that is selectable by the user making a second physical gesture; and
a display device for displaying the altered version of the real-time video image.

2. The system of claim 1, further comprising at least one of the following:
a second image capture device for capturing an image of the first product and sending data associated with the first product to the memory component; and
a printing device for printing data regarding the first product, wherein the data regarding the first product includes at least one of the following: a coupon, a rebate, product use information, and product feature information.

3. The system of claim 1, wherein the altered version of the real-time video image includes at least one of the following: price information for the first product, alternate products, use information for the first product, and results information for the first product.

4. The system of claim 1, the computer application further causing the system to provide, in response to selection of the first virtual menu option, a plurality of virtual menu sub-options, wherein the first virtual menu option and the second virtual menu option are aligned on a first virtual plane in the altered version of the real-time video image and the plurality of virtual menu sub-options are aligned on a second virtual plane in the altered version of the real-time video image.

5. The system of claim 1, the computer application further causing the system to perform at least one of the following:
communicate with the first product to receive identification data from the first product and utilize the identification data to identify the first product;
communicate with a remote device to receive identification data regarding the first product and utilize the identification data to identify the first product;
identify the first product from an audio signal; and
identify the first product from the real-time video image.

6. The system of claim 1, the computer application further causing the system to perform at least the following:
identify a second product;
include a virtual image of the second product in the altered version of the real-time video image; and
provide a comparison of the first product and the second product.

7. The system of claim 1, wherein rendering the altered version of the real-time video image includes altering the real-time video image to animate use of the first product on the user.

8. A product demonstrator device for product demonstration, comprising:
an image capture device that captures a real-time video image of a first product;
a memory component that stores a computer application, the computer application causing the product demonstrator device to perform at least the following:
identify the first product; and
render an altered version of the real-time video image, the altered version of the real-time video image a first virtual menu option that is selectable by a user making a first physical gesture and a second virtual menu option that is selectable by the user making a second physical gesture; and
a display device for displaying the altered version of the real-time video image.

9. The product demonstrator device of claim 8, further comprising at least one of the following:
a second image capture device for capturing an image of the first product and sending data associated with the first product to the memory component; and
a printing device for printing data regarding the first product, wherein the data regarding the first product includes at least one of the following: a coupon, a rebate, product use information; and
product feature data.

10. The product demonstrator device of claim 9, wherein providing data that corresponds with the first virtual menu option includes providing at least one of the following in the altered version of the real-time video image: price information for the first product, alternate products, use information for the first product, and results information for the first product.

11. The product demonstrator device of claim 9, the computer application further causing the product demonstrator device to provide, in response to selection of the first virtual menu option, a plurality of virtual menu sub-options, wherein the first virtual menu option and the second virtual menu option are aligned on a first virtual plane in the altered version of the real-time video image and the plurality of virtual menu sub-options are aligned on a second virtual plane in the altered version of the real-time video image.

12. The product demonstrator device of claim 8, the computer application further causing the product demonstrator device to perform at least one of the following:
communicate with the first product to receive identification data from the first product and utilize the identification data to identify the first product;
communicate with a remote device to receive identification data regarding the first product and utilize the identification data to identify the first product;
identify the first product from an audio signal; and
identify the first product from the real-time video image.

13. The product demonstrator device of claim 8, the computer application further causing the product demonstrator device to perform at least the following:
identify a second product;
include a second virtual product in the altered version of the real-time video image; and
provide a comparison of the first product and the second product.

14. The product demonstrator device of claim 8, wherein rendering the altered version of the real-time video image includes altering the real-time video image to animate use of the first product on the user.

15. A non-transitory computer-readable medium for product demonstration that stores a computer application that, when executed by a computer, causes the computer to perform at least the following:
identify the product;
render an altered version of a real-time video image, the altered version of the real-time video image including a first virtual menu option that is selectable by a user positioning the product in a predetermined first orientation, the altered version of the real-time video image including a second virtual menu option that is selectable by the user positioning the product in a predetermined second orientation; and
provide the altered version of the real-time video image for display.

16. The non-transitory computer-readable medium of claim 15, the computer application further causing the computer to detect a present orientation of the product and, in response to determining that the present orientation of the product corresponds to the predetermined first orientation, provide data that corresponds with the first virtual menu option for inclusion in the altered version of the real-time video image.

17. The non-transitory computer-readable medium of claim 16, wherein providing data that corresponds with the first virtual menu option includes providing at least one of the following in the altered version of the real-time video image: price information for the product, alternate products, use information for the product, and results information for the product and wherein the computer application further causes the computer to provide, in response to selection of the first virtual menu option, a plurality of virtual menu sub-options, wherein the first virtual menu option and the second virtual menu option are aligned on a first virtual plane in the altered version of the real-time video image and the plurality of virtual menu sub-options are aligned on a second virtual plane in the altered version of the real-time video image.

18. The non-transitory computer-readable medium of claim 15, the computer application further causing the computer to perform at least one of the following:
communicate with the product to receive identification data from the product and utilize the identification data to identify the product; and
identify the product from the real-time video image.

19. The non-transitory computer-readable medium of claim 15, the computer application further causing the computer to perform at least the following:
detect a present orientation of the product; and
in response to determining that the present orientation of the product corresponds to the predetermined second orientation, provide data that corresponds with the second virtual menu option for inclusion in the altered version of the real-time video image, wherein providing data that corresponds with the second virtual menu option includes providing a partially altered image of the user, the partially altered image of the user including a first portion that is unaltered and a second portion that is altered to signify a result that may be achieved by using the product.

20. The non-transitory computer-readable medium of claim 15, wherein rendering the altered version of the real-time video image includes altering the real-time video image to animate use of the product on the user.
